(19) United States
(12) Patent Application Publication
(10) Pub. No.: US 2011/0151390 A1
(43) Pub. Date: Jun. 23, 2011

(54) Orthodontic bracket

(76) Inventor: Kyoto Takemoto, Tokyo (JP)

(21) Appl. No.: 12/803,212

(22) Filed: Jun. 21, 2010

Related U.S. Application Data
(63) Continuation-in-part of application No. 12/586,814, filed on Sep. 28, 2009.

(30) Foreign Application Priority Data
Jun. 23, 2009 (JP) 2009-149185

(51) Int. Cl. A61C 7/14

(52) U.S. Cl. 433/10

(57) ABSTRACT

An orthodontic bracket is provided for correcting teeth alignment. The orthodontic bracket allows for not relying on how an operator is skilled in ligation and also for minimizing the friction. The orthodontic bracket includes a slot having an opening into which an orthodontic wire can be inserted, and a shutter that can slide to block or unblock the opening. The orthodontic wire is placed in the slot by causing the shutter to slide and unblock the opening, inserting the wire through the opening, and causing the shutter to slide and block the opening. The orthodontic wire will not disengage from the slot, whereby rotation control, tipping control, and torque control may be reliably performed. Further, it is not necessary to perform ligation that causes the wire to be securely pressed against the bottom of the slot. Since the ligation is not tight, the tooth in question can be smoothly shifted.

This application is a continuation-in-part application of and claims priority of U.S. patent application Ser. No. 12/586,814 filed on Sep. 28, 2009, which claims priority under 35 U.S.C. §119 from Japanese patent application serial no. 2009-149185, filed Jun. 23, 2009 entitled “Orthodontic Bracket”, which is incorporated herein by reference in its entirety.

### TECHNICAL FIELD

The present invention relates to an orthodontic bracket attached to a tooth to correct teeth alignment.

### BACKGROUND OF THE INVENTION

In recent orthodontics, orthodontic brackets with a shared wire have been disposed on the inner side of the teeth, that is, on the lingual side, from an aesthetic point of view (for example, refer to Japanese Examined Utility Model Application Publication No. 57-44967 and U.S. Pat. No. 4,337,037). For example, FIG. 1 illustrates a prior art orthodontic bracket 10. The orthodontic bracket 10 includes a plate-shaped pad 13 glued to a surface 12 of a tooth 11 that is on the lingual side (inner side) and a bracket body 14 integrated with the pad 13 by brazing or any other suitable method in such a way that the bracket body 14 stands erect from the pad 13 (see FIG. 1).

The bracket body 14 has a portion that looks like three fingers, which forms a main slot opening 15 and a sub-slot opening 16. On the lingual surface of the tooth 11, the main slot opening 15 is positioned vertically downward (when the orthodontic bracket 10 is used in the maxilla) or upward (when the orthodontic bracket 10 is used in the mandible). On the other hand, the sub-slot opening 16 is positioned horizontally toward the lingua. A metal wire 17 made of, for example, an alloy having a rectangular or any other suitable cross-sectional shape is then inserted into the slot 15 or 16.

The intrinsic elasticity of the wire 17 produces a bending force, a tension, or any other force as a restoring force that serves as a corrective force or moment acting on the tooth 11, which is deviated from a normal dental arc or is skewed incorrectly. Thereby, the force or moment shifts or rotates the tooth 11 over time to a position on the normal dental arc. Further, undercut portions 18 and 19, formed as upper and lower gaps between the bracket body 14 and the pad 13, are used to catch a thin wire, a rubber band, or any other suitable fastener for ligating and securing the wire 17 to the orthodontic bracket 10.

FIG. 2 shows another prior art orthodontic bracket 20. The orthodontic bracket 20 includes a pad 13, similar to the one used in the orthodontic bracket 10 of FIG. 1, and a bracket body 24 integrated with the pad 13. The bracket body 24 may include a main slot opening 25 positioned horizontally toward the lingua when the orthodontic bracket 20 is attached to the tooth 11, as shown in FIG. 2. Further, similar to the orthodontic bracket 10 of FIG. 1, upper and lower undercut portions 18 and 19 are formed between the bracket body 24 and the pad 13, and at least one of the undercut portions can be used to ligate and secure the wire 17, which is inserted in a predetermined position in the main slot opening 25.

When any of the orthodontic brackets of the prior art described above is used to perform lingual orthodontics, it has been pointed out that the ligation is a cumbersome task. In particular, an orthodontic bracket used in the maxilla with a large anterior tooth torque does not provide a large enough force to press the wire to the bottom of the slot, thereby resulting in a poor ligation using a single tie. Therefore, ligation using double over tie, which is even more cumbersome, has been proposed. When a small-sized orthodontic bracket is used, since the width of the slot is narrow and the depth thereof is shallow, it is important to perform ligation very carefully in order to reliably press the wire into the slot. If the ligation is loose, the play between the slot and the wire is large, which adversely affects the rotation and the torque control.

An orthodontic bracket having a horizontally oriented slot is problematic in that loose ligation may not allow improvement in rotation or may cause the wire to disengage from the slot during anterior retraction, resulting in torque control failure. On the other hand, when an orthodontic bracket having a vertically oriented slot is used, loose ligation may not allow tipping, height control, or sufficient torque control as well. As a result, in both the horizontally and vertically oriented slots, loose ligation prevents reliable three-dimensional tooth control. Conversely, tight ligation that allows the wire to be securely pressed against the bottom of the slot may increase the friction between the wire and the ligation wire, preventing a smooth tooth motion.

### SUMMARY OF THE INVENTION

To solve the problems described above, an object of the present invention is to provide an orthodontic bracket that does not rely on how an operator is skilled in ligation and can minimize the above mentioned friction.

In accordance with one aspect of the present invention, there is provided an orthodontic bracket for correcting a row of teeth. The orthodontic bracket includes a slot having an opening into which an orthodontic wire can vertically be inserted and a shutter that can slide to block or unblock the opening. The orthodontic wire is placed in the slot by causing the shutter to slide and unblock the opening, inserting the wire through the opening, and causing the shutter to slide and block the opening. Further, the slot has a square cross-sectional shape or a rectangle cross-sectional shape having a short side and a long side.

According to a second aspect of the present invention, the ratio of a length of a short side to a length of a long side of the slot with rectangle cross-sectional shape is more than 1.0 to not more than 1.1. Thereby, the play between the wire and the slot in the horizontal direction can approximately be the same as that in the vertical direction.

Further, according to a third aspect of the present invention, a length of the slot ranges from 1.0 to 2.0 mm or from 1.0 to 3.0 mm. Therefore, an optimum corrective force and moment can be obtained.

Moreover, according to a fourth aspect of the present invention, a position of center of the slot is determined using a ratio of distance from a crown lower end to a crown height ranging from about 0.1 to 0.5 when the orthodontic bracket is attached to the lingual side of a tooth, or from about 0.3 to 0.7 when the orthogenetic bracket is attached to a labial side of a tooth. In this way, it is possible to use an orthodontic wire having a straight configuration including a simple smooth curve, such as an arc, and straight lines connected to both ends of the curve.

In accordance with a fifth aspect of the present invention, there is provided an orthodontic bracket for correcting a row of teeth. The orthodontic bracket includes a slot through which an orthodontic wire can be placed. The slot has a square cross-sectional shape or a rectangle cross-sectional shape whose ratio of a length of a short side to a length of a long side of the rectangle is more than 1.0 to not more than 1.1. A length of the slot ranges from 1.0 to 2.0 mm or from 1.0 to 3.0 mm. Therefore, a new orthodontic bracket can be attained.

Furthermore, according to a sixth aspect of the present invention, a distance from a center of the slot to a bottom surface of the pad ranges from 0.5 to 1.5 mm when the orthodontic bracket is attached to a lingual side of a tooth, or from 0.5 to 2.0 mm when the orthogenetic bracket is attached to a labial side of a tooth. Therefore, a new orthodontic bracket can be attained.

Moreover, according to a seventh aspect of the present invention, a vertical difference of a center of the slot and an edge point of a gingival side of the bottom surface of the pad ranges from 0.5 to 1.5 mm. Therefore, a new orthodontic bracket can be attained.

Further, according to a eighth aspect of the present invention, a rotation play, a tipping play and a torque play of the orthodontic bracket are respectively controlled to be not more than 5°. Therefore, a new orthodontic bracket can be attained.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a side view of a prior art orthodontic bracket.

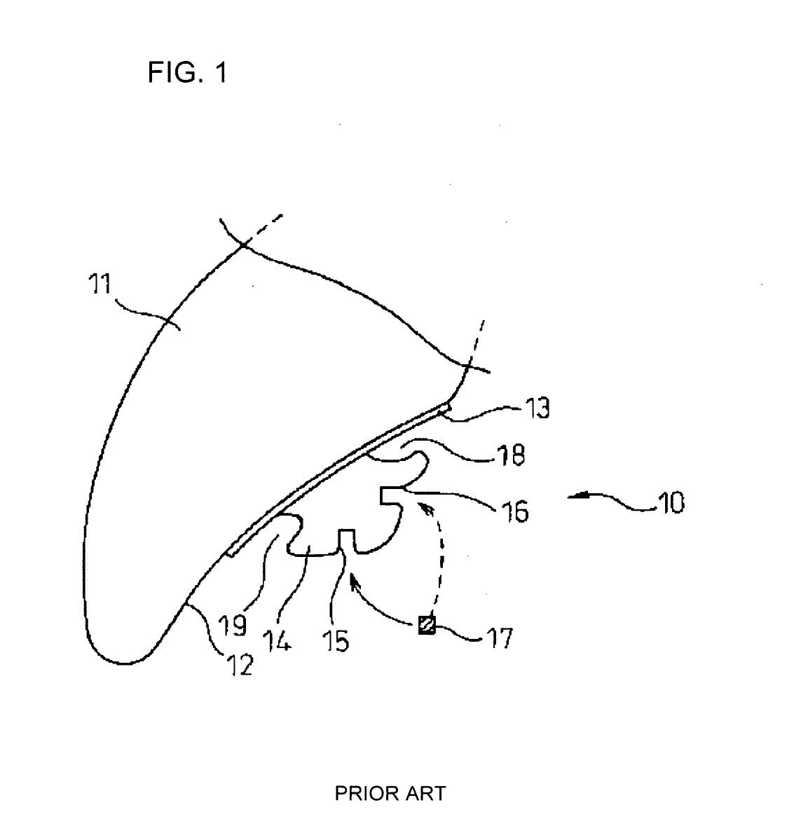

FIG. 2 is a side view of another prior art orthodontic bracket.

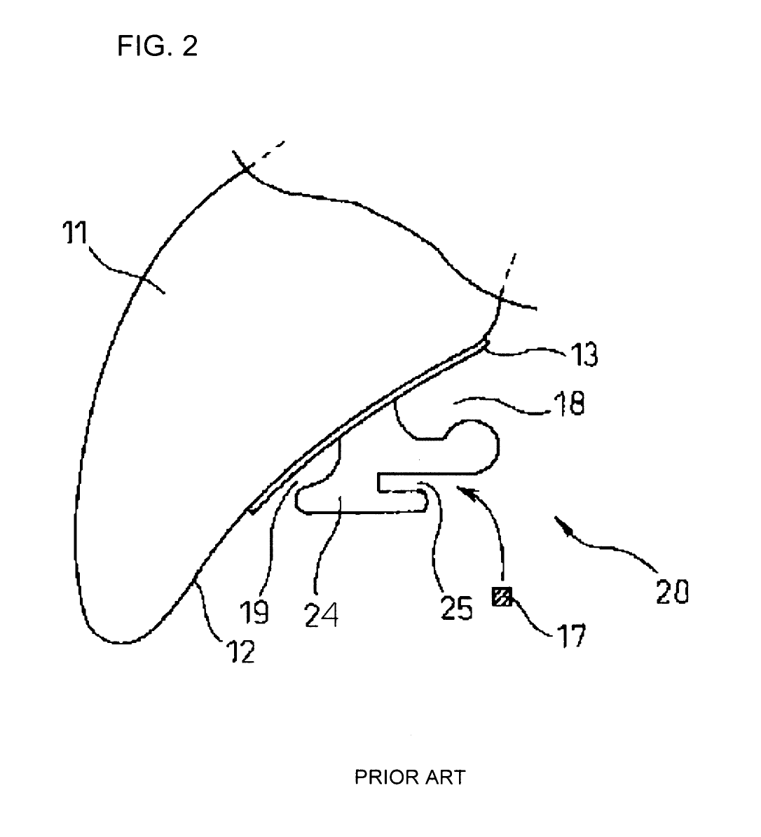

FIGS. 3A, 3B, and 3C illustrate respectively a plan view, a side view, and a bottom view of an embodiment of an orthodontic bracket.

FIG. 4 is a plan view of an orthodontic wire useable with the orthodontic bracket shown in FIGS. 3A-3C.

In the appended figures, the portion having the same or similar functions may have the same reference label and no redundant description thereof will be made in the present specification.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing the preferred exemplary embodiment(s) of the disclosure. It should be understood that various changes may be made in the function and arrangement of elements without departing from the spirit and scope of the invention as set forth in the appended claims.

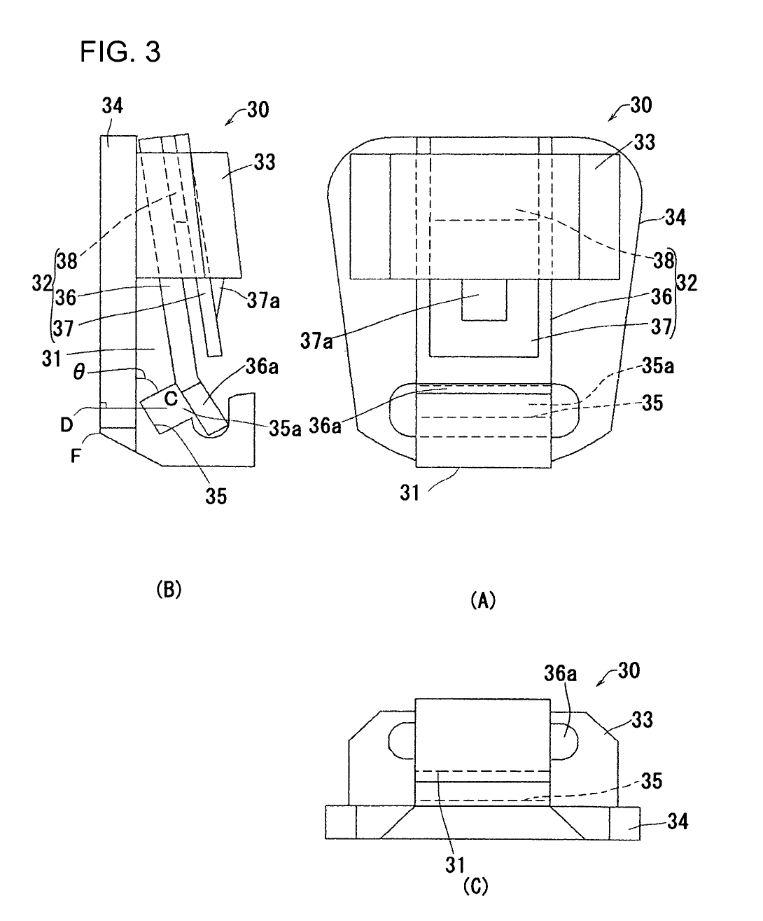

FIGS. 3A, 3B, and 3C represent, respectively, a plan view, a side view, and a bottom view of an orthodontic bracket according to one embodiment of the present invention. The orthodontic bracket 30 may include a bracket body 31, a shutter 32, a shutter holder 33, and a pad 34.

The bracket body 31 may include a slot 35, to which a wire 40, which will be described further below, can be attached. The slot 35 has a square cross-sectional shape with a short length. In addition, the slot 35 includes an opening 35a, into which the wire can be inserted, perpendicular to a bite plane (referred to as “vertical direction” hereinafter) with regards to the plane shown in FIG. 3B. Conversely, the slot of the prior art orthodontic bracket has a rectangular cross-sectional shape. In particular, when a thin round wire is used to perform leveling, the play between the slot and the wire, which are parallel to a bite plane (referred to as “horizontal direction” hereinafter) is large, and hence sufficient improvement in rotation often cannot be made. To mitigate this problem, the slot 35 of the orthodontic bracket 30 according to the present invention has a square cross-sectional shape and has a short length (a length of the slot 35 in lateral direction in FIG. 3A) so that three-dimensional control including rotation control, tipping control, and torque control may be performed with low friction.

In this embodiment, the play between the slot 35 and the wire 40 in the horizontal direction is the same as that in the vertical direction. Therefore, the rotation control, tipping control, and torque control, may be improved significantly compared to the case of rectangular slot of the prior art.

The length of one side of the slot 35, with square cross-sectional shape, ranges preferably from about 0.014 to 0.019 inches. If this length is within the above-mentioned range, an optimum corrective force and moment can be obtained by adjusting the length of the slot, the distance between the brackets, the size of the wire, and other parameters.

The length of the slot 35 may be about, for example, 1.5 mm when the orthodontic bracket 30 is used in the maxilla, whereas it may be about 1.3 mm when used in the mandible.

It is however noted that the length of the slot 35 is not limited to the values described above. The length of the slot 35 ranges preferably from about 1.0 to 2.0 mm. When the length of the slot 35 is within the above-mentioned range, an optimum corrective force and moment can be obtained by adjusting the length of one side of the square cross-sectional shape of the slot, the distance between the brackets, the size of the wire, and other parameters.

As described above, the length of the slot 35 of the orthodontic bracket 30 of the present invention, can be shorter than the length of the slot of the prior art orthodontic bracket.

Since the length of the slot 35 is shorter than the prior art's slot length, the following advantages are provided. First, reducing the length of the slot 35 allows the distance of a wire exposed between adjacent brackets (referred as “a distance of a wire between adjacent brackets” hereinafter) between adjacent brackets to be increased. Thus, a large distance between adjacent brackets prevents the orthodontic wire from being plastically deformed due to a large magnitude of stress acting thereupon. Second, no plastic deformation results in any increase in friction. Third, a corrective force based on a wire deformation can be suppressed small and an excessive force on a tooth can be prevented. Therefore, a comfort of a patient increases.

The torque θ of the slot 35, shown in FIG. 3B, ranges preferably from about 40 to 70 degrees. When the torque θ of the slot 35 is within this range, the orthodontic bracket 30 may be attached to a tooth in accordance with the form thereof.

As shown FIG. 3B, the slot 35 is formed in the bracket body 31 in such a way that the opening 35a is oriented in a substantially vertical direction, whereby the orthodontic wire 40 is readily placed in the slot 35 and at the same time the orthodontic wire 40 is readily bent in this process.

In addition, the slot 35 is positioned in a lower portion of the orthodontic bracket 30 such that when the orthodontic bracket 30 is attached to the tooth, the slot 35 is positioned toward the gingiva.

The vertical position of the centroid of the slot 35 is defined, hereinafter, as the “position of center of the slot.” The ratio of distance from the lower end of a crown of the tooth to the height of the crown is further defined as the “ratio of distance from the crown lower end to the crown height.” The preferred way of determining the position of center of the slot is to calculate the ratio of distance from the crown lower end to the crown height in such a way that this ratio ranges from about 0.1 to 0.5. In this way, a wire having a “straight configuration” formed of a simple smooth curve, such as an arc, and straight lines connected to both ends of the curve may be advantageously used.

The shutter 32 is attached to the bracket body 31 via the shutter holder 33 so that the shutter 32 slides to block or unblock the opening 35a of the slot 35. The shutter 32 includes a rectangular plate-shaped shutter body 36, a rectangular plate-shaped stopper 37, and a rectangular plate-shaped spacer 38. A lid 36a is formed at the lower end of the shutter body 36 to block or unblock the opening 35a of the slot 35. A tab 37a is also formed at the lower end of the stopper 37 so that the shutter 32 does not disengage from the shutter holder 33.

The shutter body 36 and the stopper 37 are overlaid with the spacer 38 interposed therebetween at the upper end thereof and joined with each other. The shutter holder 33 has a U-like cross-sectional shape; the upper end of the shutter 32 is inserted into a U-shaped portion, and both ends of the U-shaped portion are joined with the pad 34. When the lid 36a of the shutter body 36 blocks the opening 35a of the slot 35, the tab 37a of the stopper 37 abuts the shutter holder 33 and hence the shutter 32 does not disengage from the shutter holder 33. In this way, the lid 36a is reliably secured to cover the opening 35a of the slot 35, and serves as a sturdy inner wall of the slot 35. Pressing the lower end of the stopper 37 toward the shutter body 36, such that the stopper 37 is bent, and lifting the lower end of the stopper 37 causes the tab 37a of the stopper 37 to enter the U-shaped portion of the shutter holder 33. Since the shutter 32 can thus be lifted, the lid 36a of the shutter body 36 unblocks the opening 35a of the slot 35.

With respect to the orthodontic bracket of the present invention, the shutter 32 is securely fixed onto the opening of the slot 35 and a solid inner wall of the slot 35 can be formed. Therefore, the orthodontic bracket of the present invention does not need to have a wing just as the conventional orthodontic bracket does. Thus, the orthodontic bracket of the present invention can be formed into a small and thin orthodontic bracket. As a result, a comfort of a patient can be increased. When torque control is performed, the configured slot 35 does not allow disengagement of the wire 40 from the slot 35 during anterior retraction. Therefore, even when the wire 40 has a square cross-sectional shape, the play in the torque is small and the torque control can be sufficiently performed. Among others, since the low friction provides a smaller continuous corrective force, smooth tooth motion is likely achieved. Furthermore, since the smaller force provides a sufficient corrective force, the pain that the patient may feel at the tooth under orthodontic treatment is likely reduced.

The pad 34 has a rectangular plate shape and is integrated with the bottom of the bracket body 31 by brazing or any other suitable method. The pad 34 is glued or otherwise attached to the lingual-side surface of the tooth. Since the pad 34 is thin and attached to a portion close to the gingiva, even when the orthodontic bracket 30 is attached to an anterior tooth in the maxilla, which faces the tip of an anterior tooth in the mandible, the tip of the anterior tooth in the mandible does not tend to hit the orthodontic bracket 30. Therefore, since the orthodontic bracket 30 does not come into contact with the tip of any anterior tooth in the mandible, no gap will be formed between upper and lower molar teeth, whereby there is no risk of root resorption at the anterior tooth. It should be noted that when the pad 34 is glued onto the lingual-side surface of the tooth, any indentation in the surface of the tooth can be filled with an adhesive or the angle of the surface of the pad 34 with the surface of the tooth can be delicately adjusted by using an adhesive.

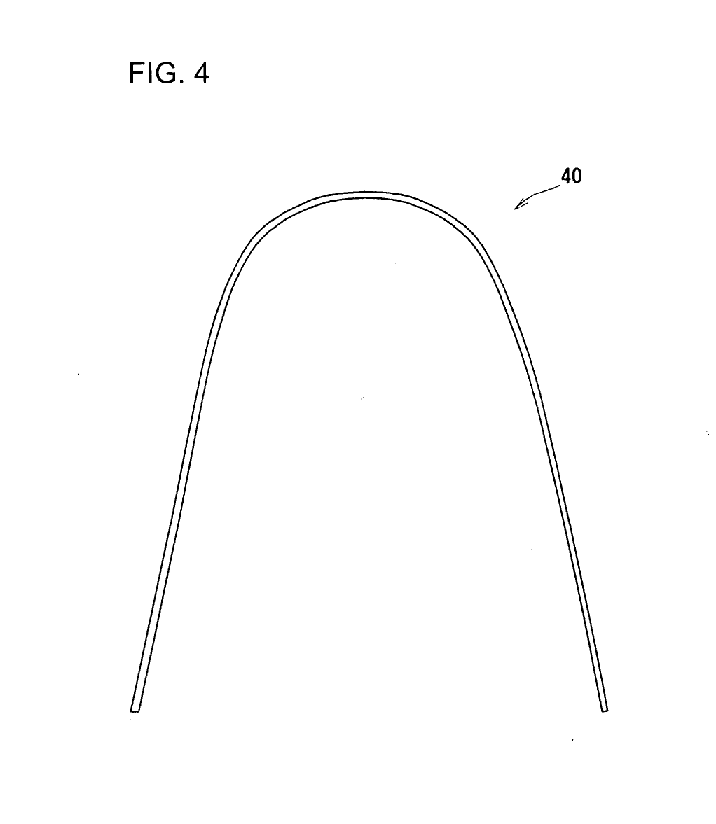

FIG. 4 illustrates a plan view of an example of an orthodontic wire useable with the orthodontic bracket 30 of the present invention. As shown in this figure, the orthodontic wire 40 has an arch-shaped portion, smoothly curved at a large radius of curvature with no sharp edges. Therefore, the orthodontic wire 40 requires almost no additional bending force to produce plastic deformation. Further, the orthodontic wire 40 has two straight portions (lines) connected to both ends of the arch-shaped curve without any step between the curve and the straight lines. Moreover, the orthodontic wire 40 has no bent portion through plastic deformation, and rests entirely in a horizontal plane when it is not biased, as shown in FIG. 4. When the orthodontic wire 40 is attached to a tooth for correction, the orthodontic wire 40 is deformed within its elasticity limit and inserted into the slot 35 of the orthodontic bracket 30. The elastic force of the orthodontic wire 40 then produces a corrective force or moment acting on the tooth via the orthodontic bracket 30. It should be noted that when a wire made of a shape memory alloy is used, the wire is deformed within its super-elasticity limit.

Since the orthodontic wire 40 does not need in advance any plastically deformed bent portion, the orthodontic wire 40 may be readily produced and industrially manufactured in volume, providing a significant cost reduction. Further, when the position of the orthodontic wire 40 is shifted and adjusted relative to the orthodontic bracket 30 in the course of orthodontic treatment, unlike the prior art's mushroom-shaped arch-wire, no cumbersome operations, such as re-bending any bent portion and re-ligation, are necessary, whereby the sliding adjustment of the orthodontic wire 40 is very readily carried out. Therefore, the burdens on both the operator and patient are reduced, and additionally the effect of individual skills among the operators is relatively diminished. Moreover, the fact that there is basically no need to bend the orthodontic wire 40 so that the shape thereof conforms to the dental arch of each individual patient is significantly advantageous. This advantage lies in the fact that it is possible to use a material which undergoes super-elastic deformation more flexibly compared to the prior art wire. As discussed previously, the prior art wire is made from a shape memory alloy such as, for example, nickel, titanium, copper, or other elements which are extremely difficult to be bent by plastic deformation.

It should be noted that when the orthodontic bracket 30 of the present invention is used in treatments, the chair time and treatment time are shortened. Additionally, shifting a tooth, such as tipping control and rotation control, is also reliably performed in a short period of time. More specifically, this period of time is reduced by an amount of about 10 to 40% compared with the case where the prior art orthodontic brackets are used.

Further, it should be also noted that the embodiments and different parameters described throughout the present disclosure are related to the case where the orthodontic bracket 30 is attached to the lingual side of the tooth. In an alternative embodiment, the orthodontic bracket 30 may be attached to the labial side of the tooth. In the following, the related parameters, such as for example the length of one side of the slot 35, the torque θ, and the position of centre of the slot 35, will be described in detail when the orthodontic bracket 30 is attached to the labial side.

In this alternative embodiment, in case when the orthodontic bracket is attached to the labial side of the tooth, the length of one side of the square cross-sectional shape of the slot 35 ranges preferably from about 0.015 to 0.022 inches. If this length is within the above-mentioned range, an optimum corrective force and moment may be obtained by adjusting the length of the slot 35, the distance between the brackets, the size of the wire, and other parameters.

Further when the orthodontic bracket 30 is attached to the labial side, the length of the slot 35 ranges preferably from about 1.0 to 3.0 mm. Furthermore, it is more preferable when the length of the slot 35 ranges from 1.0 to 2.0 mm. When the length of the slot 35 is within the range of 1.0 to 3.0 mm, an optimum corrective force and moment may be obtained by adjusting the length of one side of the square cross-sectional shape of the slot 35, the distance between the brackets, the size of the wire, and other parameters. When the length of the slot 35 is within the range of 1.0 to 2.0 mm, the effect becomes more remarkable.

Accordingly, when the orthodontic bracket is attached to the labial side, the torque θ of the slot 35 ranges preferably from about −20 to 30 degrees. When the torque θ of the slot 35 is within this range, the orthodontic bracket 30 can be attached to a tooth in accordance with the form thereof.

Moreover, when the orthodontic bracket 30 is attached to the labial side, the position of the center of the slot 35 is preferably determined so that the ratio of the distance from the crown lower end to the crown height ranges from about 0.3 to 0.7.

With respect to the above-mentioned orthodontic bracket, a shutter 32 that can slide to block or unblock the opening has been described as a method of blocking and unblocking the opening of the slot. However, the shutter 32 is not limited to the shutter 32 that can slide to block or unblock the opening of the slot

Further, as the other method of blocking and unblocking the opening of the slot, a hinge cap can be employed. It is preferable that the hinge cap resists the reactive force of the orthodontic wire and is securely fixed into the opening of the slot. In this way, a solid inner wall of the slot can be formed and the orthodontic wire does not slip out of the slot. Thus, a rotation control, a tipping control and a torque control can securely be performed.

With respect to the above-mentioned orthodontic bracket, a slot having the opening into which an orthodontic wire 40 can be inserted in a vertical direction has been described above. However, the slot is not limited to a slot having an opening into which an orthodontic wire can be inserted in vertical direction.

Further, a slot may have an opening into which an orthodontic wire can be inserted from the other direction, such as a horizontal direction. The process of placing the orthodontic wire in the slot becomes simple by arbitrarily changing the orientation of the opening of the slot corresponding to the work environment. Also the process of arching the orthodontic wire is simplified.

With respect to the above-mentioned orthodontic bracket, a slot with square cross-sectional shape has been described above. However, the slot is not limited to a square cross-sectional shape. Further, the slot can have a rectangle cross-sectional shape as long as the rectangle cross-sectional shape is within the predetermined range.

In case when attaching the orthodontic bracket on the lingual side of the tooth, the length of one side of the slot, with square cross-sectional shape, ranges preferably from 0.014 to 0.019 inches. The length of one side of the slot, with rectangle cross-sectional shape, ranges preferably from 0.014 to 0.019 inches. With respect to the slot with rectangle cross-sectional shape, the ratio of the length of the short side to the length of the long side of the slot is preferably more than 1 and not more than 1.1. Further, it is more preferable when the ratio of the length of the short side to the length of the long side ranges from more than 1 to not more than 1.05.

In case when the orthodontic bracket is attached to the labial side of a tooth, the length of one side of the slot 35, with square cross-sectional shape, ranges preferably from 0.015 to 0.022 inches. The length of one side of the slot, with rectangle cross-sectional shape, ranges preferably from 0.015 to 0.022 inches. Further, with respect to the slot 35 with rectangle cross-sectional shape, the ratio of the length of the short side to the length of the long side of the slot 35 ranges preferably from more than 1 to not more than 1.1. Furthermore, it is more preferable when the ratio of the length of the short side to the length of the long side of the slot with rectangle cross-sectional shape ranges from more than 1 to not more than 1.05.

Since the cross-section of the slot 35 is a square shape or a rectangle shape within the predetermined range, the play between the orthodontic wire and the slot 35 can be suppressed small. Further, the rotation control, tipping control and torque control can securely be performed. In addition, the number of the orthodontic wire changed in the period from the primary stage to the terminal stage can be lessened.

The cross-sectional shape of the slot 35 does not need to be strict square or rectangle. For example, a corner of the square shape or the rectangle shape may be curved. Further, for example, a corner or one part of a side of the square shape or the rectangle shape may be shaved off. In other words, the cross-sectional shape of the slot 35 needs to be a shape that can securely suppress the play between the slot 35 and orthodontic wire small.

The play, which has been expressed in degrees, between the slot 35 and the orthodontic wire in rotation, tipping and torque is respectively defined as a rotation play, tipping play and torque play. It is preferable that the rotation play, the tipping play and the torque play are respectively not more than 5°. Further, it is more preferable when the rotation play, the tipping play and the torque play are independently and respectively not more than 3°. The rotation control, the tipping control and the torque control can be securely performed by respectively having the rotation play, tipping play and torque play within the predetermined range.

In case when the orthodontic bracket is attached to the lingual side of the tooth, the stiffness of the orthodontic wire is preferably not more than 1500. Further, it is more preferable when the stiffness of the orthodontic wire is not more than 1000.

In case when the orthodontic bracket is attached to the labial side of the tooth, the stiffness of the orthodontic wire is preferably not more than 2000. Further, it is more preferable that the stiffness of the orthodontic wire is not more than 1500. The optimum corrective force and moment can be realized without putting excessive force on a tooth by utilizing the orthodontic wire with the stiffness within the predetermined range. The stiffness refers to an index expressed by a ratio of the bending stiffness value of the target orthodontic wire to a reference value. Here, the reference value is the bending stiffness value of a stainless steel orthodontic wire having an elliptical cross-section of φ0.004 inches.

In FIG. 3B, the centroid of the slot 35 with a square cross-sectional shape (or a rectangle cross-sectional shape) is defined as “center of the slot”. A plane, which attaches to a tooth, of the pad 34 is defined as “bottom surface.” A vertical line is drawn from the center C of the slot 35 to the bottom surface of the pad 34. Then the point where the vertical line and the bottom surface meet is defined to be D. The distance between C and D is defined as “distance between the center of the slot and the bottom surface of the pad.”

In case when the orthodontic bracket is attached to the lingual side of the tooth, the distance between the center of the slot 35 and the bottom surface of the pad 34 ranges preferably from 0.5 to 1.5 mm. Further, it is more preferable that the distance between the center of the slot 35 and the bottom surface of pad 34 ranges from 0.5 to 1.0 mm. When the distance between the center of the slot 35 and the bottom surface of the pad 34 is within the above-mentioned range, a change in an in-out and a height of a tooth can be suppressed small in torque control. Further, the length of the orthodontic wire between adjacent brackets can be lengthened. Thus, the corrective force caused by the deformation of the orthodontic wire can be suppressed small. Further, since the excessive force on a tooth can be prevented, the comfort of the patient increases.

In case when the orthodontic bracket is attached to the labial side of a tooth, the distance between the center of the slot 35 and the bottom surface of the pad 34 ranges preferably from 0.5 to 2.0 mm. Further, it is more preferable when the distance between the center of the slot 35 and the bottom surface of the pad 34 ranges from 0.5 to 1.5 mm. When the distance between the center of the slot 35 and the bottom surface of the pad 34 is within the above-mentioned range, a change in an in-out and a height of a tooth can be suppressed small in torque control.

In FIG. 3B, an edge point of the gingival side of the bottom surface of the pad 34 is defined as F. The distance between D and F is defined as “a vertical difference of the center of the slot 35 and the edge point of the gingiva side of the bottom surface of the pad.”

In case when the orthodontic bracket is attached to the lingual side of the tooth, the vertical difference of the center of the slot 35 and the edge point of the gingival side of the bottom surface of the pad 34 ranges preferably from 0.5 to 1.5 mm. Further, it is more preferable when the vertical difference between the center of the slot 35 and the edge point of the gingival side of the bottom surface of the pad 34 ranges from 0.5 to 1.0 mm. When the vertical difference between the center of the slot 35 and the edge point of the gingival side of the bottom surface of the pad 34 is within the above-mentioned range, a straight orthodontic wire having a simple and smooth circular arch and a straight line connected to both sides of the circular arch can be utilized. Further, the length of the orthodontic wire between the adjacent brackets can be lengthened. Thus, the corrective force caused by the deformation of the orthodontic wire can be suppressed. Furthermore, since the excessive force on a tooth can be prevented, the comfort of the patient is increased.

While the principles of the disclosure have been described above with specific embodiments, it is to be clearly understood that this description is made only by way of example and not as limitation on the scope of the invention.

What is claimed is:

1. An orthodontic bracket comprising:
a slot having an opening into which an orthodontic wire can be inserted; and
a shutter that can slide to block or unblock the opening,
wherein the orthodontic wire is placed in the slot by causing the shutter to slide and unblock the opening, inserting the wire through the opening, and causing the shutter to slide and block the opening,
wherein the slot has a square cross-sectional shape or a rectangular cross-sectional shape having a short side and a long side.

2. The orthodontic bracket according to claim 1, wherein a ratio of the short side to the long side ranges 1.0 to 1.1.

3. The orthodontic bracket according to claim 1, wherein a length of the slot ranges from about 1.0 to 3.0 mm.

4. The orthodontic bracket according to claim 1, wherein a position of center of the slot is determined using a ratio of a distance from a crown lower end to a crown height ranging from about 0.1 to 0.5 when the orthodontic bracket is attached to the lingual side of a tooth, and ranging from about 0.3 to 0.7 when the orthogenetic bracket is attached to a labial side of a tooth.

5. An orthodontic bracket comprising:
a slot through which an orthodontic wire can be placed,
wherein the slot has been formed into a square cross-sectional shape or a rectangular cross-sectional shape having a short side and a long side,
wherein a ratio of the short side to the long side of the rectangular cross sectional shape ranges more than 1.0 to not more than 1.1
wherein a length of the slot ranges from about 1.0 to 3.0 mm.

6. The orthodontic bracket according to claim 5, further comprising:
a pad, onto which a bracket including the slot is attached,
wherein a distance from a center of the slot to a bottom surface of the pad ranges from 0.5 to 1.5 mm when the orthodontic bracket is attached to a lingual side of a tooth, and ranges from 0.5 to 2.0 mm when the orthogenetic bracket is attached to a labial side of a tooth.

7. The orthodontic bracket according to claim 5, wherein a distance from a center of the slot to an edge point of a lingual-side surface of a tooth in a height direction ranges from 0.5 to 1.5 mm.

8. The orthodontic bracket according to claim 5, wherein a play of rotation, a play of tipping and a play of torque of the orthodontic bracket are respectively controlled not more than 5°.

9. An orthodontic bracket comprising:
a slot having an opening into which an orthodontic wire can be inserted; and
a shutter that can slide to block or unblock the opening,
wherein the orthodontic wire is placed in the slot by causing the shutter to slide and unblock the opening, inserting the wire through the opening, and causing the shutter to slide and block the opening,
wherein a length of the slot ranges from about 1.0 to 3.0 mm.

10. The orthodontic bracket according to claim 9,
wherein a position of center of the slot is determined using a ratio of a distance from a crown lower end to a crown height ranging from about 0.1 to 0.5 when the orthodontic bracket is attached to the lingual side of a tooth, and ranging from about 0.3 to 0.7 when the orthogenetic bracket is attached to a labial side of a tooth.
